(19) United States
(12) Patent Application Publication
(10) Pub. No.: US 2026/0162020 A1
(43) Pub. Date: Jun. 11, 2026

(54) SYSTEM AND METHOD TO ENABLE NETWORK FUNCTION -BASED FEDERATED LEARNING IN CORE NETWORK

(71) Applicant: Huawei Technologies Co., Ltd., Shenzhen (CN)

(72) Inventors: Abbas Kiani, Vieanna, VA (US); Khosrow Tony Saboorian, Plano, TX (US); Zhixian Xiang, Frisco, TX (US); Kaippallimalil Mathew John, Carrollton, TX (US)

(21) Appl. No.: 19/538,356

(22) Filed: Feb. 12, 2026

Related U.S. Application Data
(63) Continuation of application No. PCT/US2024/041795, filed on Aug. 9, 2024.
(60) Provisional application No. 63/519,476, filed on Aug. 14, 2023.

(51) Int. Cl. G06N 20/00

(52) U.S. Cl. CPC G06N 20/00

(57) ABSTRACT

According to implementations, a federated learning (FL) server network entity receives information about local machine learning (ML) models from FL client network entities. Each local ML model of the local ML models is trained based on respective local training data. The respective local training data is available at a respective FL client network entity of the FL client network entities before the respective FL client network entity receives a corresponding FL training request. The FL server network entity aggregates the local ML models to generate an updated global ML model.

### CROSS-REFERENCE TO RELATED APPLICATION

This patent application is a continuation of International Application No. PCT/US2024/041795, filed on Aug. 9, 2024, and entitled “System and Method to Enable Network Function-Based Federated Learning in Core Network,” which claims priority to U.S. Provisional Application No. 63/519,476, filed on Aug. 14, 2023, and entitled “System and Method to Enable NF-Based Federated Learning in 5G Core,” applications of which are hereby incorporated by reference herein as if reproduced in their entireties.

### TECHNICAL FIELD

The present disclosure relates generally to network communications, and in particular embodiments, to techniques and mechanisms for enabling network function (NF)-based federated learning in the Core Network.

### BACKGROUND

The network data analytics function (NWDAF) is part of the 5-th generation (5G) core and uses the mechanisms and interfaces specified for 5G core (5GC) in TS 23.501 and TS 23.288. The NWDAF is the 5G network analytics producer which may interact with several entities for different purposes. The NWDAF may perform data collection from other 5G network functions (NFs), application function (AF), and operations, administration and management (OAM). The NWDAF may also retrieve information from data, and provision on demand analytics to network analytics consumers such as other network functions (NFs), OAM, user equipment (UE), and AF. 3GPP has specified functionalities at the NWDAF to perform model training and derive analytics. Each NWDAF may contain two logical functionalities including model training logical function (MTLF) and/or analytics logical function (AnLF). FIG. 1 is an example network diagram showing NWDAF inside a 5G core and its interfaces (N2, N3, N4, N6) to other network entities which can consumer analytics from NWDAF or provide data to NWDAF.

The MTLF trains machine learning (ML) models and exposes the training models via existing services such as Nnwdaf_MLModelProvision and/or Nnwdaf_MLModelInfo.

The AnLF performs inference based on the trained ML model from the MTLF, derives analytics information (e.g., derives statistics and/or predictions based on the Analytics Consumer request), and exposes analytics via services such as Nnwdaf_AnalyticsSubscription and/or Nnwdaf_AnalyticsInfo. The following tables show an example of analytics parameters (e.g., predictions generated at the NWDAF AnLF) and the corresponding training data. In Table 1, M represents the name of an ML model. In Table 2, “A,”, “P,” and “U” are example names of data features. Examples of features may include data rate, latency, etc.

TABLE 1
An example of data analytics generated at NWDAF

| Analytics Parameter | Corresponding ML model |
|---|---|
| Prediction Parameter X | M |
| Prediction Parameter Y | M |

TABLE 2
An example of training data features required
to train ML model M from Table 1

| Data Feature | Data Producer NF |
|---|---|
| A | NF 1 (e.g., AMF) |
| P | NF 2 (e.g., PCF) |
| U | NF 3 (e.g., UPF) |

There are MTLF and AnLF interactions. To retrieve an ML model from an NWDAF containing the MTLF, an NWDAF containing AnLF may be locally configured with a set of IDs of the NWDAFs containing MTLF(s) and their corresponding supported Analytics ID(s) and/or may use the NWDAF discovery procedures for discovering NWDAFs containing MTLF(s). An NWDAF containing AnLF may subscribe/unsubscribe to an NWDAF containing MTLF providing input parameters including a list of Analytics ID(s) for which the requested ML model is used. When a subscription for a trained ML model associated with an Analytics ID is received, the NWDAF containing MTLF(s) may determine whether the existing trained ML model(s) can be used or whether further training of the existing trained ML model(s) is needed. In the case of further training, the NWDAF containing MTLF may initiate input data collection from NFs, UEs, AF, and/or OAM. For each Analytics ID requested by the NWDAF containing AnLF, the NWDAF containing MTLF may provide a set of pair(s) of unique ML model identifier(s) and the ML model information which includes the ML model file address (e.g., uniform resource locator (URL) or fully qualified domain name (FQDN)).

Federated learning (FL) among multiple NWDAFs (e.g., clause 5.3 of TS 23.288) is a machine learning technique in the 5G core network that trains an ML model across multiple decentralized NWDAFs including one FL server NWDAF (NWDAF containing MTLF with server capability) and multiple FL client NWDAFs (NWDAFs containing MTLF with client capability). When performing FL among NWDAFs, the FL client NWDAFs can train ML model based on their local data set without exchanging/sharing the local data set to the FL server NWDAF or other FL client NWDAFs. In Release 18, horizontal FL among NWDAFs is supported in which the local data set in different FL client NWDAFs has the same feature space but different samples. Each NWDAF containing MTLF may register its FL capability type (i.e., FL server and/or FL client if it supports FL) with its NF profile in the network repository function (NRF).

### FL Server NWDAF Functionality

The FL server NWDAF main functions to enable FL includes discovery and selection of FL client NWDAFs to participate in the FL procedure, sending requests to the FL client NWDAFs to perform local model training and to report local model information, generating a global ML model by aggregating local model information from the FL client NWDAFs, sending the global ML model back to the FL client NWDAFs, and repeating the training iteration if needed. The FL server NWDAF also needs to provide an initial model to each FL client NWDAF when the FL procedure is started.

### FL Client NWDAF Functionality

The FL client NWDAF main functions to enable FL includes local training of the ML model requested by the FL server NWDAF using its available local data set, reporting the trained local ML model information to the FL server NWDAF, receiving the global ML model feedback from FL server NWDAF, and repeating the training iteration if needed.

FIG. 2 shows an example of interactions between the analytics consumer, the NWDAF, and the data producer NF when no FL is performed to generate the requested analytics. It is assumed that prediction parameters X and Y in Table 1 need to be generated for which ML model M is required to be trained first via training data features of Table 2.

FIG. 3 shows an example of interactions between the analytics consumer, the NWDAF server 204, the NWDAF clients, and the data producer NFs when the Rel-18 FL method is performed across NWDAFs. As shown in FIG. 3, NWDAF clients still need to collect input data (e.g., data features A, P, U from data producers NF 201, NF 202, and NF 203, respectively, required for local training) from data producer NFs. However, NWDAF 222 and NWDAF 224 may be unable to access the input data.

### SUMMARY

Technical advantages are generally achieved, by embodiments of this disclosure which describe methods and apparatus.

According to implementations, a federated learning (FL) server network entity receives information about local machine learning (ML) models from FL client network entities. Each local ML model of the local ML models is trained based on respective local training data. The respective local training data is available at a respective FL client network entity of the FL client network entities before the respective FL client network entity receives a corresponding FL training request. The FL server network entity aggregates the local ML models to generate an updated global ML model.

In some implementations, the FL client network entities may comprise one or more of at least one core domain network entity, at least one radio access network (RAN) network entity, at least one application function (AF) entity, or at least one user equipment (UE). The at least one RAN network entity may include at least one base station. The at least one core domain network entity may include an access and mobility management function (AMF) entity, a policy control function (PCF) entity, a session management function (SMF) entity, a user plane function (UPF) entity, a network exposure function (NEF) entity, or a network repository function (NRF) entity.

In some implementations, the FL server network entity may determine whether network function (NF)-based FL is required based on an analytics identifier (ID) and based on corresponding data collection requirements. The FL server network entity may determine a mechanism for the NF-based FL.

In some implementations, the FL server network entity may perform an NF-based FL registration and discovery procedure based on the mechanism.

In some implementations, the FL server network entity may send a server registration profile to a network repository function (NRF) entity. The server registration profile may indicate FL server capability information. The FL server network entity may send a discovery request to the NRF entity. The FL server network entity may receive a discovery response from the NRF entity. The discovery response may indicate a set of candidate FL client network entities. The FL server network entity may send FL learning preparation requests to the set of candidate FL client network entities. Each of the FL learning preparation requests may indicate ML model information, the analytics ID, and the corresponding data collection requirements. The FL server network entity may receive FL learning preparation responses from the set of candidate FL client network entities. The FL server network entity may select the FL client network entities from the set of candidate FL client network entities based on the FL learning preparation responses.

In some implementations, the FL server network entity may perform an NF-based FL training procedure based on the mechanism. The FL server network entity may perform the NF-based FL training procedure via at least one of enhanced ML model provision or ML model training service operations.

In some implementations, the FL server network entity may receive a subscription request from an ML model consumer. The FL server network entity may send FL training requests to the FL client network entities. The FL server network entity may receive FL training responses from FL client network entities. These FL training responses may include the information about the local ML models.

In some implementations, the FL client network entities may include NF entities of a same NF type.

In some implementations, the FL client network entities may include NF entities of different NF types.

In some implementations, the FL server network entity may be an FL server network data analytics function (NWDAF) entity.

In some implementations, the mechanism may be a horizontal mechanism, a vertical mechanism, or a horizontal and vertical mechanism.

In some implementations, at least a part of the respective local training data available at the respective FL client network entity may be produced by the respective FL client network entity.

According to implementations, an FL client network entity locally generates or collects training data. After the local generation or collection, the FL client network entity receives an FL training request from an FL server network entity. The FL client network entity trains a local machine learning (ML) model based on the FL training request and the training data. The FL client network entity sends information about the local ML model to the FL server network entity.

In some implementations, the FL client network entities may comprise one or more of at least one core domain network entity, at least one radio access network (RAN) network entity, at least one application function (AF) entity, or at least one user equipment (UE). The at least one RAN network entity may include at least one base station. The at least one core domain network entity may include an access and mobility management function (AMF) entity, a policy control function (PCF) entity, a session management function (SMF) entity, a user plane function (UPF) entity, a network exposure function (NEF) entity, or a network repository function (NRF) entity.

In some implementations, the FL client network entity may send a network entity registration profile to a network repository function (NRF) entity. The network entity registration profile may indicate FL client capability information. The FL client network entity may receive an FL learning preparation request from the FL server network entity. The FL learning preparation request may indicate ML model information, an analytics identifier (ID), and corresponding data collection requirements. The FL client network entity may determine to join network function (NF)-based FL corresponding to the local ML model with the FL server network entity based on the FL learning preparation request. The FL client network entity may send an FL learning preparation response to the FL server network entity.

In some implementations, the FL client network entity may receive information about an updated global ML model from the FL server network entity. The FL client network entity may update the local ML model based on the updated global ML model. In some implementations, at least a part of the training data available at the FL client network entity may be produced by the FL client network entity.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an example network diagram showing NWDAF inside a 5G core and its interfaces to other network entities;

FIG. 2 shows an example of interactions between the analytics consumer, the NWDAF, and the data producer NF when no FL is performed;

FIG. 3 shows an example of interactions between the analytics consumer, the NWDAF server, the NWDAF clients, and the data producer NFS;

FIG. 4 shows an example where FL is performed across the server NWDAF and the data producer NFs enhanced with model training functionality, according to some implementations;

FIG. 5 shows an example of vertical and/or horizontal FL between the FL server NWDAF and the NFs enhanced with MTLF functionality, according to some implementations;

FIG. 6 shows an example of horizontal FL between the FL server NWDAF and NFs enhanced with MTLF of the same NF type, according to some implementations;

FIG. 7 shows an example of vertical FL between the FL server NWDAF and NFs enhanced with MTLF of different NF types, according to some implementations;

FIG. 8 shows an example of vertical FL between FL server and network entities enhanced with MTLF from different domains, according to some implementations;

FIG. 9 shows a flow diagram of an example method at an NWDAF containing MTLF to determine if and/or what mechanism for FL is required, according to some implementations;

FIG. 10 shows a diagram of an example procedure for FL registration and discovery, according to some implementations;

FIG. 11 shows a diagram of an example procedure for FL registration and discovery, according to some implementations;

FIG. 12 is a diagram showing an example procedure for interactions between FL server NWDAF, FL client NFs, and ML model consumer to perform FL, according to some implementations;

FIG. 13A shows a flow chart of a method performed by a federated learning (FL) server network entity, according to some implementations;

FIG. 13B shows a flow chart of a method performed by a federated learning (FL) client network entity, according to some implementations;

FIG. 14 illustrates an example communications system, according to some implementations;

FIG. 15 illustrates an example communication system, according to some implementations;

FIGS. 16A and 16B illustrate example devices that may implement the methods and teachings according to this disclosure, according to some implementations; and

FIG. 17 is a block diagram of a computing system that may be used for implementing the devices and methods disclosed herein, according to some implementations.

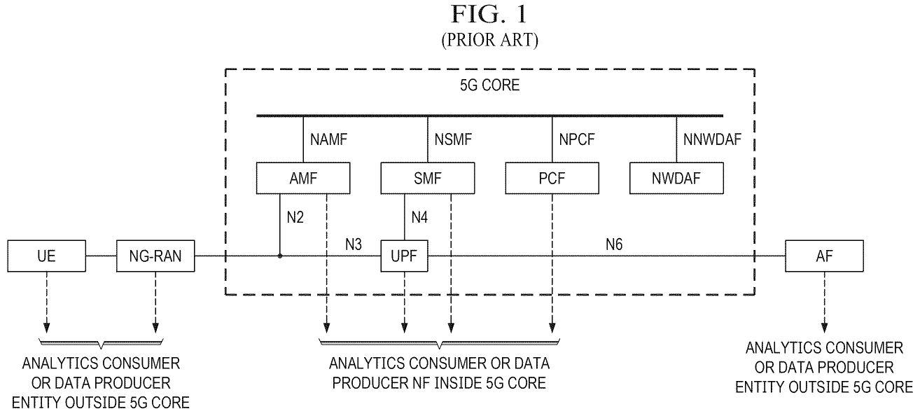

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

As specified in Release 18, when receiving a request from a NWDAF containing AnLF to train an ML model, the NWDAF containing MTLF may determine that a FL technique is needed based on different factors including the Analytic ID (e.g., for statistics/predictions output data parameters), service area, or when the input data cannot be directly obtained from data producer NFs due to reasons such as data security or data privacy. If the NWDAF containing MTLF cannot act as a FL server NWDAF for the requested ML model, it first discovers and selects an FL server NWDAF from the NRF (e.g., via Nnrf_NFDiscovery_Request service operation) using filtering criteria such as Analytic ID of the ML model required, FL capability type (e.g., FL server), checking if the selected server NWDAF is currently executing an federated learning (FL) procedure for the Analytics ID, and/or the time period of interest and service area.

Once the FL server NWDAF is determined, the FL server NWDAF discovers and selects FL client NWDAFs from the NRF (e.g., via Nnrf_NFDiscovery_Request service operation) using filtering criteria such as Analytic ID of the ML model required, FL capability type (e.g., FL client), service area, data availability by the client NWDAF, and/or the time period of interest.

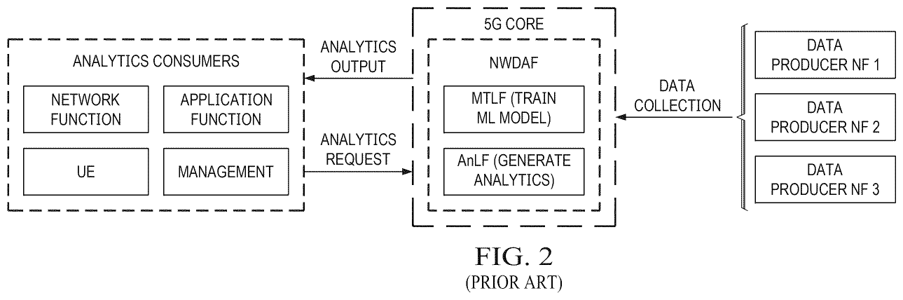

The Release 18 approach has technical limitations. FL among NWDAFs may address the security/privacy issues when data cannot be directly collected by the FL server NWDAF due to reasons such as the data producer NF is from a different vendor than the FL server NWDAF or the data producer NF is in a different serving area than the FL server NWDAF for which a FL client NWDAF from the same vendor or in the same serving area is leveraged. However, to locally train the required ML model, each FL client NWDAF needs to either collect local data from the local data producer NFs (e.g., NFs in its serving area) or leverage the available local data set from previously collected data (see e.g., FIG. 2). Therefore, technical issues can occur that the client NWDAFs cannot collect data from the data producer NFs due to data security/privacy/access-rights concerns. Release 19 artificial intelligence machine learning (AIML) work tasks (WTs) (SP-230759) have been identified to address the shortcoming.

The current Release 18 FL solutions do not address data security/privacy/access-rights concerns for cases where the FL client/server NWDAF cannot obtain local data from a data producer NF. In an example, an ML model that needs to be trained based on the data of a user plane function (UPF) are located at a private network (i.e., data producer NF for that ML model). However, due to data security/privacy issues, the UPF cannot share/exchange its local data with the FL server/client NWDAF on the commercial network. Therefore, new FL based technical solutions to address data collection limitations from data producer NFs having data security/privacy issues are desirable.

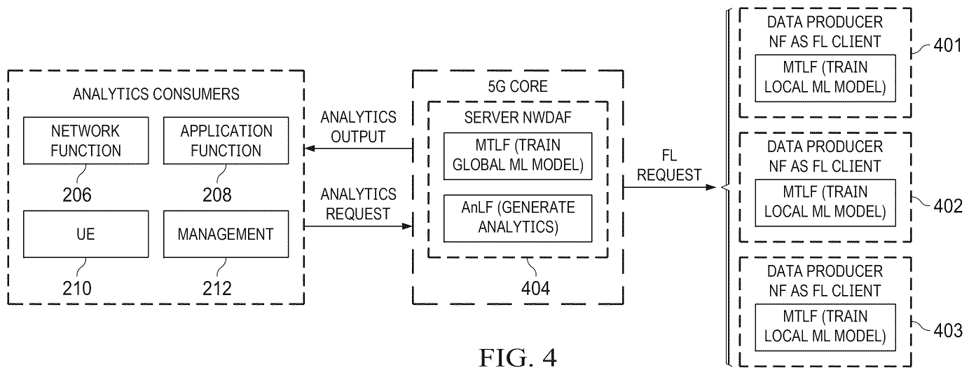

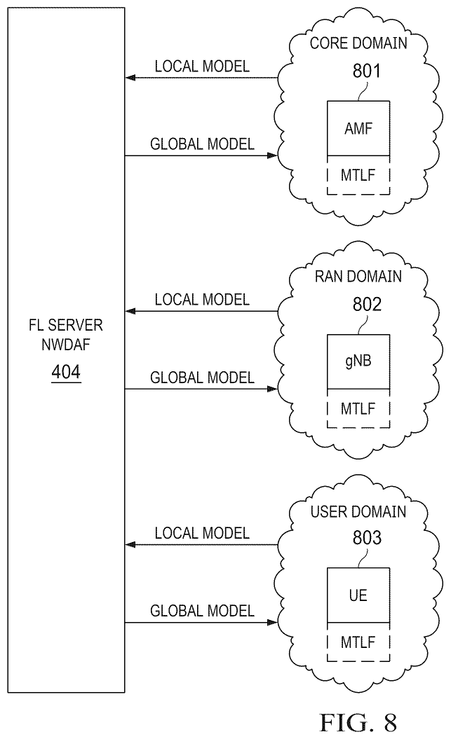

This disclosure describes techniques to enhance the data producer NFs (or other network entities) with MTLF functionality to enable FL among an FL server NWDAF and multiple NFs acting as FL clients. In so doing, data collection from data producer NFs which have data security/privacy/access-rights issues can be eliminated. In other words, a data producer NF itself may participate in FL by local training of an ML model via its available local data while the FL server capability is still implemented on the NWDAF (see e.g., FIGS. 4-8). FIG. 8 shows that NFs are not limited to 5GC NFs, and the disclosed technique can be extended to other network entities, such as UE(s) and gNB(s) from different domains (e.g., radio access network (RAN) domain, core domain). Therefore, the described FL architecture can be a technical solution to work task 3 (i.e., ‘Study the following potential enhancements to enable 5G system to assist cross-domain (e.g. UE, 5G Core, application, OAM) application AI training and inference (so-called “Vertical Federated Learning (VFL)”)’) of the Release 19 AIML enhancements study/work item. That is, by enhancing network entities from different domains with MTLF functionality, the FL technique which is currently performed only between NWDAFs in the core domain can be extended across different domains.

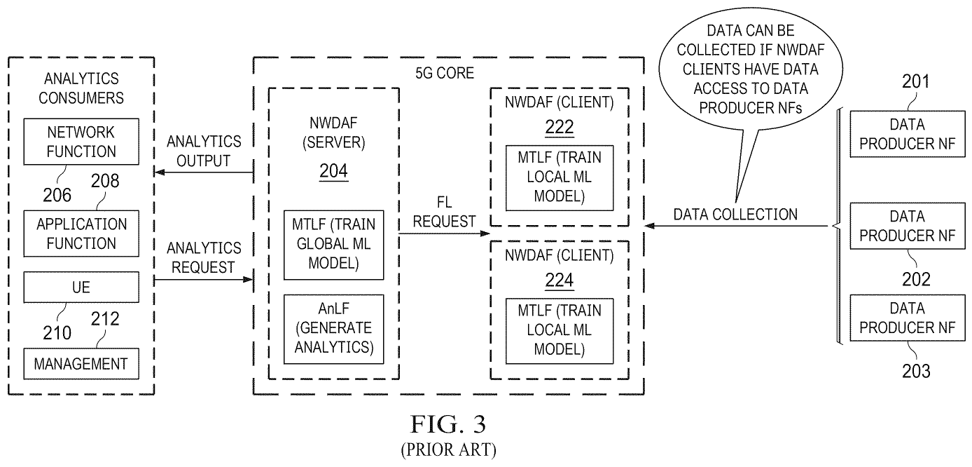

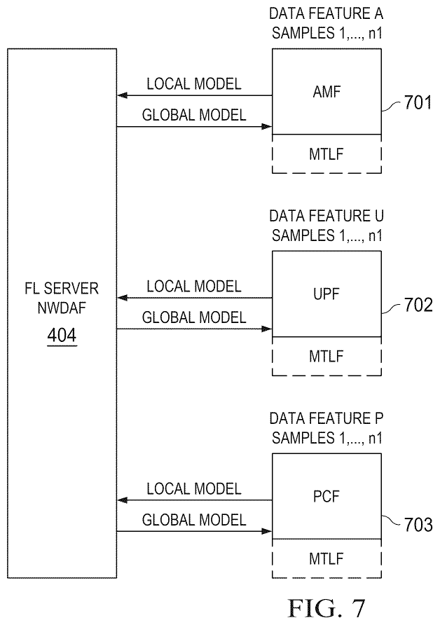

In Release 18, there is no support of NF as a FL client. Future releases may support NF as a FL client as shown in FIG. 4. FIG. 4 shows an example where FL is performed across the server NWDAF 404 and the data producer NFs (e.g., NFs 401-403, and/or so on) enhanced with model training functionality, according to some implementations. Although not shown in FIG. 4, a server NWDAF connecting to one or more NFs as a client and one or more NDWAF clients can be supported. Points 1-10 of the below example describes a comparison between the existing FL method (e.g., FIG. 3) (points 1-7), problem description (point 8), and described FL techniques (e.g., FIG. 4 to FIG. 8) (points 9-10). As shown in FIG. 7, the described FL techniques can also solve technical issues of WT 3.1 (e.g., “how to support feature determination and alignment across domains when applying the VFL operation”) and WT 3.2 (e.g., “how to identify/select the required NF(s) within the 5G Core domain corresponding to the local feature in order to collaborate on the VFL operation (i.e. training or inference)”). That is, as shown in FIG. 7, features to apply vertical federated learning (VFL) operation can be determined based on NF types. For the example in FIG. 7, the FL operation requires training based on AMF, UPF, and PCF data where these NF types can be mapped to data features A, U and P described above.

Regarding point 1, there is an analytics consumer of data analytics inside (e.g., a 5GC network function)/outside the network (e.g., an application function (AF)), such as the NF 206, the AF 208, the UE 210, and the management function 212. For example, the NF 206 may be an access and mobility management function (AMF) inside the network that requires UE mobility analytics (UE location prediction, etc.) generated by the server NWDAF 204.

Regarding point 2, the analytics consumer may send a request to an NWDAF (e.g., the NWDAF 204) for the analytics.

Regarding point 3, the NWDAF 204 may need to train a corresponding ML model of the requested analytics before inference (generating analytics) by the NWDAF 204.

Regarding point 4, the ML model training may require training data.

Regarding point 5, in an existing solution, when the NWDAF 204 does not have access to collect training data from source data producers (data producers are other NFs (e.g., NFs 201-203) in the 5GC), it triggers federated learning, e.g., the NWDAF 204 (FL server) reaches out to, for example, the NWDAF 222 and the NWDAF 224 (FL clients), which may have access to the training data.

Regarding point 6, the NWDAF 222 and the NWDAF 224 collect the training data from data producer NFs (e.g., NFs 201-203), each of them trains a ML model locally based on the collected training data. Then, the FL clients (e.g., the NWDAF 222 and the NWDAF 224) share locally trained model with the NWDAF 204 (FL server).

Regarding point 7, in existing solutions, the NWDAFs 222 and 224 still need to collect training data from data producer NFs (e.g., NFs 201-203).

However, regarding point 8, NWDAF 222 or 224 may not be able to collect the training data from data producer NFs (e.g., NFs 201-203) due to privacy or security constraints.

In some implementations, the server NWDAF 404 can perform everything that the NWDAF 204 in FIG. 2 can perform, and data producer NFs 401-403 can perform everything that the data producer NFs 201-203 in FIG. 2 can perform. In addition, regarding point 9, this disclosure describes techniques to enhance NFs with model training functionalities such that the enhanced NFs (e.g., NFs 401-403) can act as FL clients and train local ML models on their own data. Therefore, instead of sharing raw training data with NWDAFs (e.g., NWDAFs 202, 222, and 224), the data producing NFs (e.g., NFs 401-403) can share locally trained data (e.g., local models, which do not have privacy/security concerns) with the NWDAFs (e.g., the server NWDAF 404).

In other words, regarding point 10, according to some implementations, FL between the NWDAF 204 (FL server) and NWDAFs 222 and 224 (FL clients) may be changed to FL between the server NWDAF 404 and the data producer NFs (e.g., NFs 401-403).

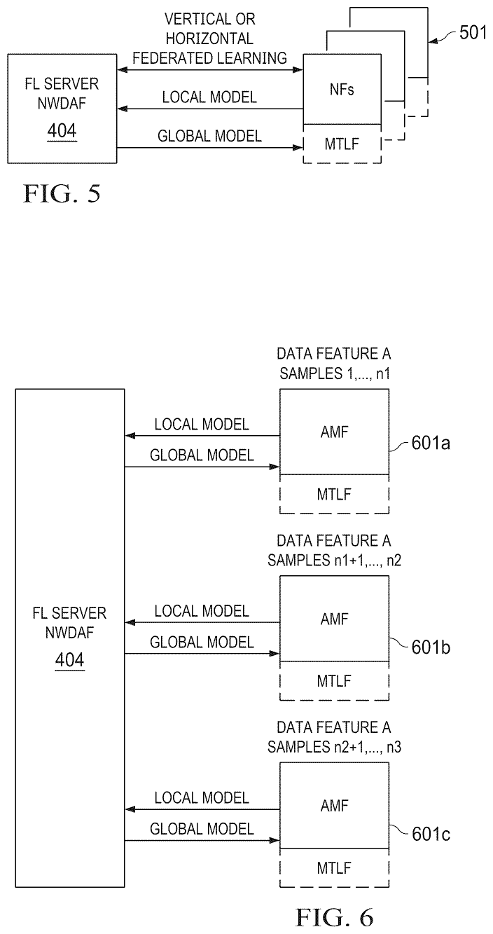

FIG. 5 shows an example of vertical and/or horizontal FL between the FL server NWDAF (e.g., the server NWDAF 404) and the NFS 501 (which may be NFs 401-403) enhanced with MTLF functionality acting as FL clients, according to some implementations. The server NWDAF 404 may send its current global model to the NFS 501 as an initial model for training local models of the NFs 501. Each NF of the NFs 501 produces training data and utilizes its MTLF functionality to train its local model based on the initial model received from the server NWDAF 404 and the training data generated by the NF. The NFS 501 then may send their respective trained local models to the server NWDAF 404. The server NWDAF 404 generated the updated global model by aggregating the received local models using aggregation technique known in the art. The above processes can be repeated for multiple iterations.

FIG. 6 shows an example of horizontal FL between the FL server NWDAF (e.g., the server NWDAF 404) and NFs enhanced with MTLF of the same NF type (e.g., AMFs 601) having same data features acting as FL clients, according to some implementations. The NFS 501 described with respect to FIG. 5 may include NFs of the same NF type (e.g., AMFs 601a-c). Further, with horizontal FL, the local data sets (e.g., training data) in different NFs have the same feature space (e.g., data feature A) but different samples (e.g., for different users each corresponding to a different sample, such as samples 1 to n1 produced and/or collected by AMF 601a, samples n1+1 to n2 produced and/or collected by AMF 601b, and samples n2+1 to n3 produced and/or collected by AMF 601c). For example, the same feature shared by the NFs for horizontal FL may be the data feature for latency, and the different samples may be different latency statistics for different users generated by different NFs (e.g., AMFs 601a-c). In another example, the feature shared by the NFs for horizontal FL may be the data feature for quality of service (QoS), and the different samples may be different QoS statistics for different users generated by different NFs (e.g., AMFs 601a-c).

FIG. 7 shows an example of vertical FL between the FL server NWDAF (e.g., the server NWDAF 404) and NFs enhanced with MTLF of different NF types (e.g., AMF 701, UPF 702, and policy control function (PCF) 703) having different data features acting as FL clients, according to some implementations. The NFs 501 described with respect to FIG. 5 may include NFs of different NF types (e.g., AMF 701, UPF 702, and PCF 703). Further, with vertical FL, the local data sets in different NFs have different feature spaces (e.g., data feature A for AMF 701, data feature U for UPF 702, data feature P for PCF 703) but the same samples (samples 1 to n1 for users 1 to n1, respectively).

FIG. 8 shows an example of vertical FL between FL server NWDAF (e.g., the server NWDAF 404) and network entities enhanced with MTLF from different domains (e.g., RAN domain, core domain, and UE domain) having different data features acting as FL clients, according to some implementations. The NFs 501 described with respect to FIG. 5 may include the NF (e.g., AMF) 801 in the core domain, the gNB 802 in the RAN domain, and the UE 803 in the user domain.

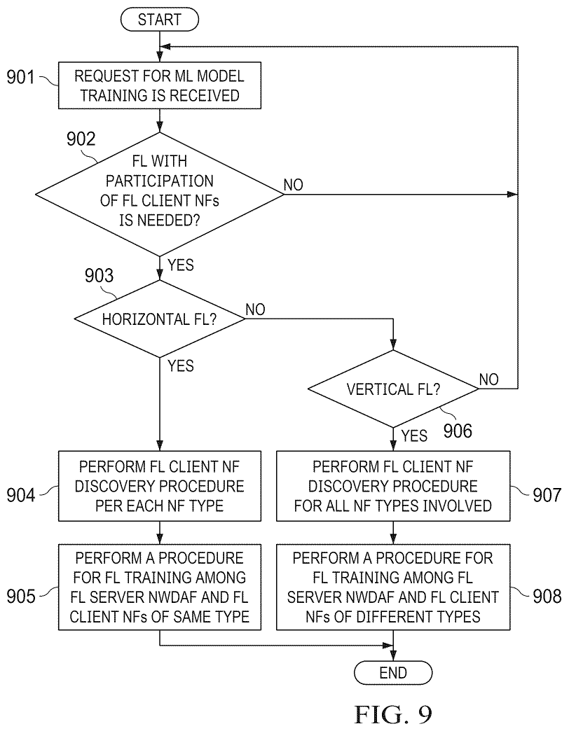

FIG. 9 is a flow diagram showing an example method at an NWDAF containing MTLF (e.g., an NF 501) to determine if and/or what mechanism for FL is required, according to some implementations. As shown in FIG. 9, at operation 901, a request for FL ML model training is received at the NWDAF containing MTLF (e.g., a request from the NWDAF containing AnLF, for example, the server NWDAF 404). At the operation 902, the NWDAF containing MTLF may determine FL with participation of FL client NFs is required because either input data cannot be collected from data producer NFs or no FL client NWDAF is discovered for the filtering criteria via existing FL client NWDAF discovery procedures. Such determination can be performed based on the Analytics ID in the request. For example, the requested Analytics ID requires ML training based on data feature A of NF type AMF. However, due to data access constraints, data feature A cannot be collected from the AMF via any NWDAF clients. Therefore, it is determined that FL with participation of AMF enhanced with MTLF functionality is needed. At the operation 903, the NWDAF containing MTLF may further decide if a horizontal FL is needed (e.g., based on analytics ID, required input data, data privacy/security/access-rights reasons, NFs involved in ML model training, etc.). In case of horizontal FL, the corresponding procedure for FL client NF discovery per each NF type is performed in the operation 904. Accordingly, procedures to perform FL training among the FL server NWDAF (e.g., the server NWDAF 404) and FL client NFs (e.g., NFS 501) from the same NF type are followed in the operation 905. If vertical FL is decided at the operation 906, procedures for FL client NF discovery and FL training for different NF types involved in FL are performed in the operations 907 and 908, respectively.

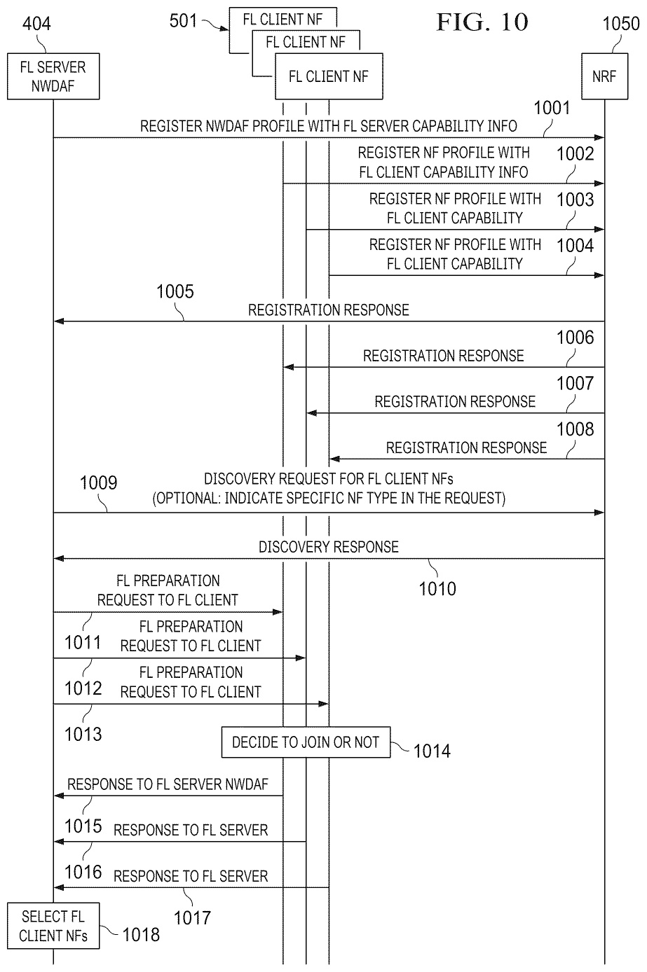

FIG. 10 is a diagram showing an example procedure for interactions between an FL server NWDAF (the server NWDAF 404), FL client NFs (NFs 501), and an NRF to perform registration and discovery for FL, according to some implementations. 3GPP standardized subscribe interfaces, notify interfaces, and/or a modified version of them (e.g., Nnwdaf_MLModelProvision and/or Nnwdaf_MLModelInfo) may be used here at each operations of interactions between FL server NWDAF, FL client NFs, and the NRF. The following Nnwdaf_MLModelProvision service operations may be enhanced and implemented on all NF supporting MTLF functionality. These service operations are currently supported only by NWDAF. The service name may be changed according to NF type but the same Input and Output data parameters specified in TS 23.288 can be leveraged as the Input/Output parameters are ML model information related not specific to NF type information.

- Service operation name: N{NFtype}_MLModelProvision_Subscribe (e.g.,
Namf_MLModelProvision_Subscribe)
Description: Subscribes to FL client NF ML model provision.
- Service operation name: N{NFtype}_MLModelProvision_Unsubscribe
(e.g., Namf_MLModelProvision_Unsubscribe)
Description: unsubscribe to FL client NF ML model provision.
- Service operation name: N{NFtype}_MLModelProvision_Notify
(e.g., Namf_MLModelProvision_Notify)
Description: FL client NF notifies the ML model information to the NWDAF server which has
subscribed to the FL client NF service.
The following Nnwdaf_MLModelInfo service operation can also be enhanced and
supported by all NF supporting MTLF functionality. This service operation is currently
supported only by NWDAF. The service name may be changed according to NF type but same
Input and Output data parameters specified in TS 23.288 can be leveraged as the Input/Output
parameters are ML model information related not specific to NF type information.
- Service operation name: N{NFtype}_MLModelInfo_Request
(e.g., Namf_MLModelInfo_Request)
Description: The FL server NWDAF requests FL client NF ML Model Information.

As shown in FIG. 10, in the operation 1001, the FL server NWDAF 404 registers its NWDAF profile with FL server capability information in the NRF 1050. An example of NF profile (e.g., clause A.2 TS 29.510) enhanced with a new parameter as shown below.

```
NFProfile:
  description: Information of an NF Instance registered in the NRF
  type: object
  required:
    - nfInstanceId
    - nfType
    - nfStatus
  anyOf:
    - required: [ fqdn ]
    - required: [ ipv4Addresses ]
    - required: [ ipv6Addresses ]
  properties:
    nfInstanceId:
      $ref: ‘TS29571_CommonData.yaml#/components/schemas/NfInstanceId’
    nfInstanceName:
      type: string
    nfType:
      $ref: ‘#/components/schemas/NFType’
    nfStatus:
      $ref: ‘#/components/schemas/NFStatus’
    FLCapabilityType: client or None
      type: array
```

In operations 1002-1004, each FL client NF 501 registers its NF profile (e.g., NFProfile above) information enhanced with FL client capability information in the NRF 1050. NF registration responses are sent by the NRF in the operations 1005-1008. In the operation 1009, the FL server NWDAF 404 discovers and selects NFs with FL client capability from the NRF. For this operation, the FL server NWDAF 404 may send a discovery request to the NRF 1050 (e.g., invoke the 3GPP standardized Nnrf_NFDiscovery_Request service operation and use criteria including Analytic ID of the required ML model, FL capability type (i.e., FL client), service area, vendor, security domain, interoperability information, and data availability by the FL client NFs). It may be assumed that before the 1009 of this procedure, the NWDAF containing MTLF which has received Analytics request from the Analytics consumer has determined that the ML model requires vertical/horizontal FL and the corresponding training data cannot be directly obtained from the data producer NFs, and the NWDAF containing MTLF has discovered and selected an NWDAF with server capability via existing procedures. The discovery response to the discovery request at the operation 1009 is received at the operation 1010. In operations 1011-1013, the FL server NWDAF 404 sends FL learning preparation request to the discovered FL client NFS 501. The FL preparation request may include information such as the required ML model, analytics ID, and data requirements. In the operation 1014, the FL client NFs 501 check if they can meet the ML model training requirements and accordingly decide whether to join the FL process. The FL client NF 501's responses are sent back to the FL server NWDAF 404 in the operations 1015-1017, and the FL server NWDAF 404 selects FL client NF(s) 501 in operation 1018 based on the received responses (from FL clients NF(s) 501 that have decided to join).

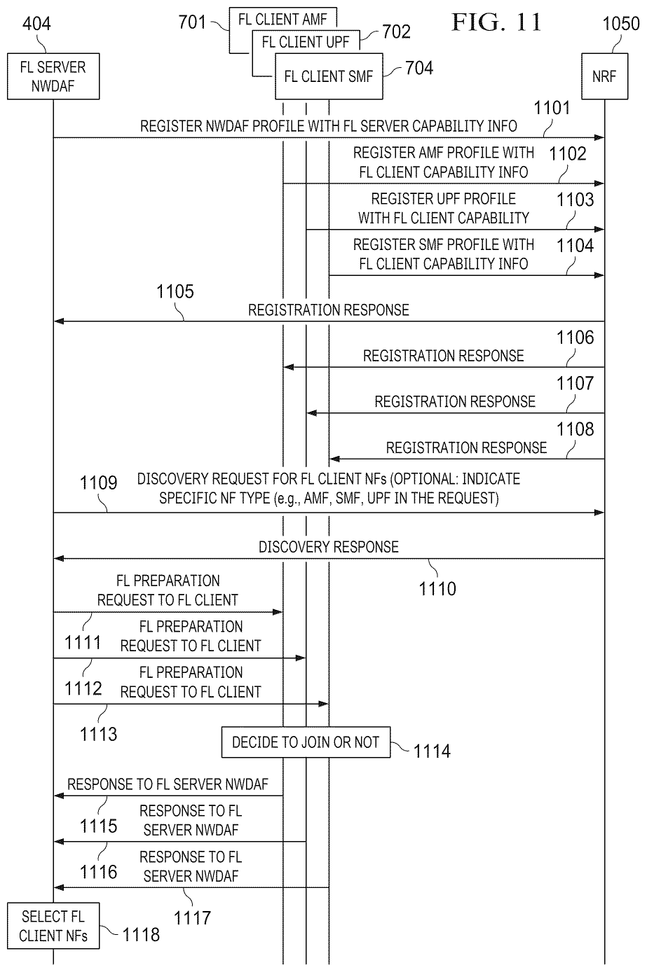

FIG. 11 is a diagram of an example procedure for FL registration and discovery with example NF types, according to some implementations. The operations 1101-1118 in FIG. 11 are similar to the operations 1001-1018 except that examples of the NFS 501 in FIG. 10 may include the AMF 701, the UPF 702, and the session management function (SMF) 704. The NFS 501 are not limited to the NFs shown in FIG. 11. The NFs 501 may also include any NF produces training data for its local model. The NFs 501 may further be extended to other network entities, such as the gNB 802 and the UE 803 described with respect to FIG. 8.

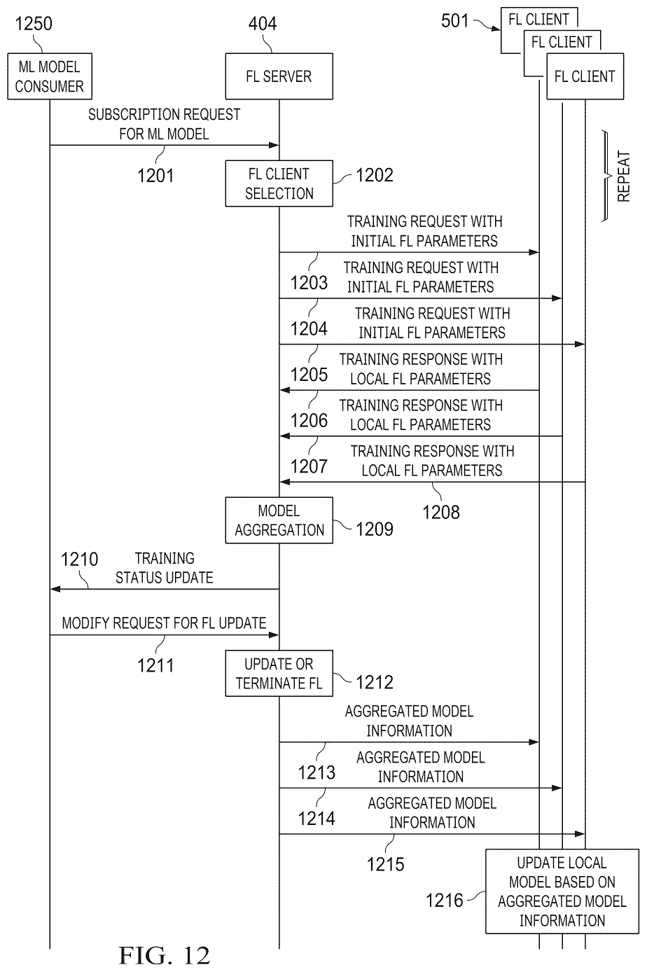

FIG. 12 is a diagram showing an example procedure for interactions between FL server NWDAF (e.g. the server NWDAF 404), FL client NFs (e.g., the NFs 501), and ML model consumer 1250 to perform FL among the FL server NWDAF and FL client NFs, according to some implementations. 3GPP standardized subscribe interfaces, notify interfaces may be used here at each operation of interactions between each two entities. For example, the Nnwdaf_MLModelTraining Service which enables the FL server/client to subscribe/unsubscribe/notify/modify for ML model training can be used on NFs enhanced with MTLF capability. This service enables the FL server NWDAF 404 to enable federated learning (FL) while providing global ML model information to FL client NWDAF and getting local ML model information and status report of FL training. The service operation Nnwdaf_MLModelTraining may be enhanced and implemented on all NF supporting MTLF functionality. The service name may be changed according to NF type but same Input and Output data parameters specified in TS 23.288 can be leveraged as the Input/Output parameters are ML model information related not specific to NF type information. Note that the current Nnwdaf_MLModelTraining service is used by an NWDAF to request an NWDAF containing MTLF to prepare training ML model or modify existing ML Model training subscription.

- Service operation name: N{NFtype}_MLModelTraining_Notify
(e.g., Namf_MLModelTraining_Notify)
Description: FL client NF notifies the consumer instance of the trained ML model (i.e., FL server
NWDAF) that has subscribed to the specific NWDAF service. The FL client NF can also use this
service to indicate to FL server NWDAF that it will terminate the ML model training.

As shown in FIG. 12, in the operation 1201, the ML consumer 1250 (note that the ML consumer may be different from an analytics consumer, which is an NWDAF containing AnLF or NWDAF containing MTLF) sends a subscription request (e.g., N{NFtype}_MLModelProvision_Subscribe) to the FL server NWDAF 404 to train an ML model via horizontal/vertical NF-based FL. In the operation 1202, the FL server NWDAF 404 selects FL client NFs (e.g., via the discovery procedure described with respect to FIG. 10). The FL server NWDAF 404 sends FL training request(s) (e.g., N{NFtype}_MLModelInfo_Request) to the selected FL client NF(s) in the operations 1203-1205. The FL server NWDAF 404 may include FL information such as the ML model accuracy in its training request. The FL client NF(s) 501 perform a FL training procedure using the locally produced training data to produce their respective local model(s), and send their respective local ML model information (e.g., N{NFtype}_MLModelProvision_Notify) back to the FL server NWDAF 404 in the operations 1206-1208. In the operations 1209, the FL server NWDAF 404 aggregates local ML information and updates the global ML model. In the operation 1210, the FL server NWDAF 404 sends a notification update to the ML consumer 1250 to update the global ML model. Based on the updated global model received from the FL server NWDAF 404, the ML consumer 1250 decides whether continue or stop FL process in the operation 1211 and sends the corresponding request to the FL server NWDAF. In the operation 1212, the FL server NWDAF 404 either updates or terminates the FL process. In case that the FL process continues, the FL server NWDAF 404 sends the global FL model information to the FL client NFs in the operations 1213-1215. The FL client NF(s) 501 update their FL local models based the received aggregated (i.e., global) model in the operation 1216. The operations 1206-1219 can be repeated until a FL training termination condition is met based on the feedback from ML consumer or maximum number of iterations is reached.

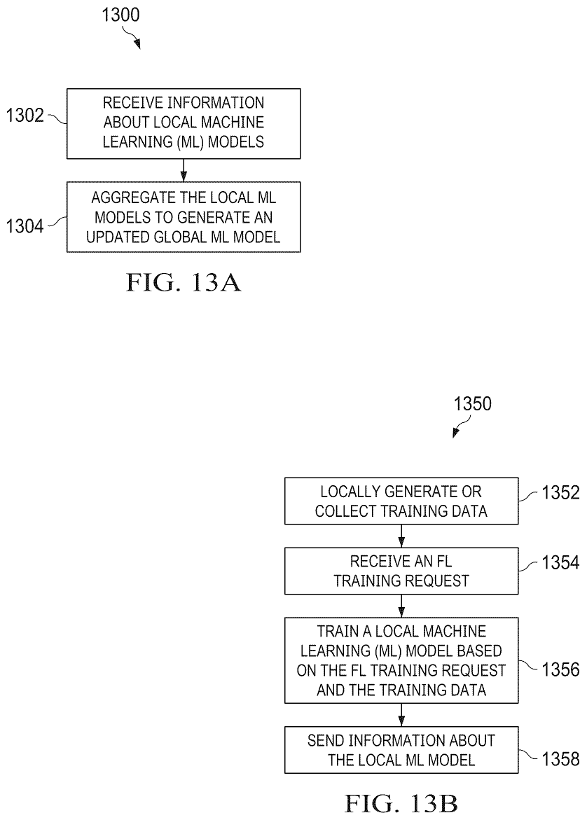

FIG. 13A shows a flow chart of a method 1300 performed by a federated learning (FL) server network entity, according to some implementations. The FL server network entity may include computer-readable code or instructions executing on one or more processors of the FL server network entity. Coding of the software for carrying out or performing the method 1300 is well within the scope of a person of ordinary skill in the art having regard to the present disclosure. The method 1300 may include additional or fewer operations than those shown and described and may be carried out or performed in a different order. Computer-readable code or instructions of the software executable by the one or more processors may be stored on a non-transitory computer-readable medium, such as for example, the memory of the FL server network entity. In some embodiments, the method 1300 may be performed by one or more of units or modules (e.g., an integrated circuit) of the FL server network entity, such as field programmable gate arrays (FPGAs) or application-specific integrated circuits (ASICs).

The method 1300 starts at the operation 1302, where a federated learning (FL) server network entity receives information about local machine learning (ML) models from FL client network entities. Each local ML model of the local ML models is trained based on respective local training data. The respective local training data is available at a respective FL client network entity of the FL client network entities before the respective FL client network entity receives a corresponding FL training request. At the operation 1304, the FL server network entity aggregates the local ML models to generate an updated global ML model.

In some implementations, the FL client network entities may comprise one or more of at least one core domain network entity, at least one radio access network (RAN) network entity, at least one application function (AF) entity, or at least one user equipment (UE). The at least one RAN network entity may include at least one base station. The at least one core domain network entity may include an access and mobility management function (AMF) entity, a policy control function (PCF) entity, a session management function (SMF) entity, a user plane function (UPF) entity, a network exposure function (NEF) entity, or a network repository function (NRF) entity.

In some implementations, the FL server network entity may determine whether network function (NF)-based FL is required based on an analytics identifier (ID) and based on corresponding data collection requirements. The FL server network entity may determine a mechanism for the NF-based FL.

In some implementations, the FL server network entity may perform an NF-based FL registration and discovery procedure based on the mechanism.

In some implementations, the FL server network entity may send a server registration profile to a network repository function (NRF) entity. The server registration profile may indicate FL server capability information. The FL server network entity may send a discovery request to the NRF entity. The FL server network entity may receive a discovery response from the NRF entity. The discovery response may indicate a set of candidate FL client network entities. The FL server network entity may send FL learning preparation requests to the set of candidate FL client network entities. Each of the FL learning preparation requests may indicate ML model information, the analytics ID, and the corresponding data collection requirements. The FL server network entity may receive FL learning preparation responses from the set of candidate FL client network entities. The FL server network entity may select the FL client network entities from the set of candidate FL client network entities based on the FL learning preparation responses.

In some implementations, the FL server network entity may perform an NF-based FL training procedure based on the mechanism. The FL server network entity may perform the NF-based FL training procedure via at least one of enhanced ML model provision or ML model training service operations.

In some implementations, the FL server network entity may receive a subscription request from an ML model consumer. The FL server network entity may send FL training requests to the FL client network entities. The FL server network entity may receive FL training responses from FL client network entities. These FL training responses may include the information about the local ML models.

In some implementations, the FL client network entities may include NF entities of a same NF type.

In some implementations, the FL client network entities may include NF entities of different NF types.

In some implementations, the FL server network entity may be an FL server network data analytics function (NWDAF) entity.

In some implementations, the mechanism may be a horizontal mechanism, a vertical mechanism, or a horizontal and vertical mechanism.

In some implementations, at least a part of the respective local training data available at the respective FL client network entity may be produced by the respective FL client network entity.

FIG. 13B shows a flow chart of a method 1350 performed by a federated learning (FL) client network entity, according to some implementations. The FL client network entity may include computer-readable code or instructions executing on one or more processors of the FL client network entity. Coding of the software for carrying out or performing the method 1350 is well within the scope of a person of ordinary skill in the art having regard to the present disclosure. The method 1350 may include additional or fewer operations than those shown and described and may be carried out or performed in a different order. Computer-readable code or instructions of the software executable by the one or more processors may be stored on a non-transitory computer-readable medium, such as for example, the memory of the FL client network entity. In some embodiments, the method 1350 may be performed by one or more of units or modules (e.g., an integrated circuit) of the FL client network entity, such as field programmable gate arrays (FPGAs) or application-specific integrated circuits (ASICs).

The method 1350 starts at the operation 1352, where an FL client network entity locally generates or collects training data. At the operation 1354, after the local generation or collection, the FL client network entity receives an FL training request from an FL server network entity. At the operation 1356, the FL client network entity trains a local machine learning (ML) model based on the FL training request and the training data. At the operation 1358, the FL client network entity sends information about the local ML model to the FL server network entity.

In some implementations, the FL client network entities may comprise one or more of at least one core domain network entity, at least one radio access network (RAN) network entity, at least one application function (AF) entity, or at least one user equipment (UE). The at least one RAN network entity may include at least one base station. The at least one core domain network entity may include an access and mobility management function (AMF) entity, a policy control function (PCF) entity, a session management function (SMF) entity, a user plane function (UPF) entity, a network exposure function (NEF) entity, or a network repository function (NRF) entity.

In some implementations, the FL client network entity may send a network entity registration profile to a network repository function (NRF) entity. The network entity registration profile may indicate FL client capability information. The FL client network entity may receive an FL learning preparation request from the FL server network entity. The FL learning preparation request may indicate ML model information, an analytics identifier (ID), and corresponding data collection requirements. The FL client network entity may determine to join network function (NF)-based FL corresponding to the local ML model with the FL server network entity based on the FL learning preparation request. The FL client network entity may send an FL learning preparation response to the FL server network entity.

In some implementations, the FL client network entity may receive information about an updated global ML model from the FL server network entity. The FL client network entity may update the local ML model based on the updated global ML model. In some implementations, at least a part of the training data available at the FL client network entity may be produced by the FL client network entity.

The following reference is incorporated by reference in this disclosure.

- TS23.288:
https://www.3gpp.org/ftp/Specs/archive/23_series/23.288/23288-i20.zip

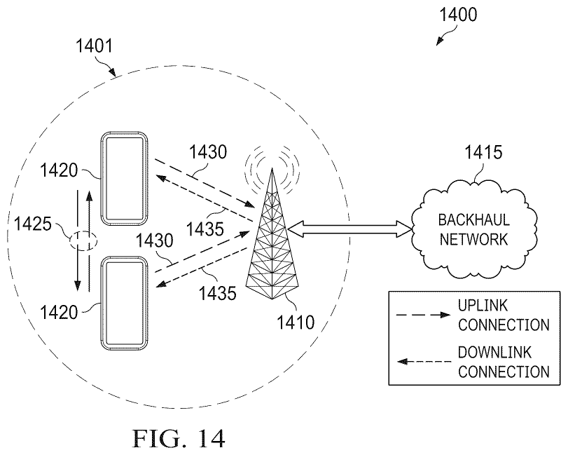

FIG. 14 illustrates an example communications system 1400. Communications system 1400 includes an access node 1410 serving user equipments (UEs) with coverage 1401, such as UEs 1420. In a first operating mode, communications to and from a UE passes through access node 1410 with a coverage area 1401. The access node 1410 is connected to a backhaul network 1415 for connecting to the internet, operations and management, and so forth. In a second operating mode, communications to and from a UE do not pass through access node 1410, however, access node 1410 typically allocates resources used by the UE to communicate when specific conditions are met. Communications between a pair of UEs 1420 can use a sidelink connection (shown as two separate one-way connections 1425). In FIG. 14, the sideline communication is occurring between two UEs operating inside of coverage area 1401. However, sidelink communications, in general, can occur when UEs 1420 are both outside coverage area 1401, both inside coverage area 1401, or one inside and the other outside coverage area 1401. Communication between a UE and access node pair occur over uni-directional communication links, where the communication links between the UE and the access node are referred to as uplinks 1430, and the communication links between the access node and UE is referred to as downlinks 1435.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

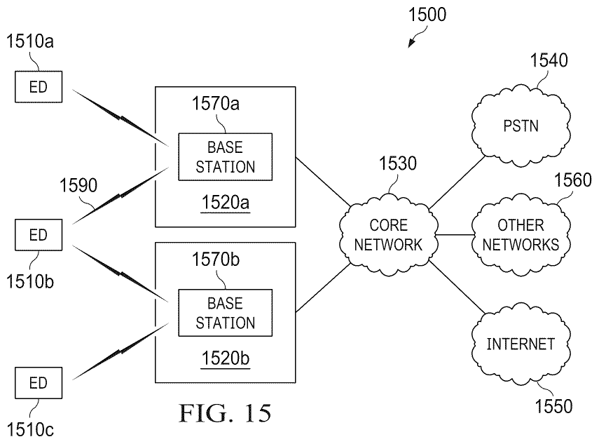

FIG. 15 illustrates an example communication system 1500. In general, the system 1500 enables multiple wireless or wired users to transmit and receive data and other content. The system 1500 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1500 includes electronic devices (ED) 1510a-1510c, radio access networks (RANs) 1520a-1520b, a core network 1530, a public switched telephone network (PSTN) 1540, the Internet 1550, and other networks 1560. While certain numbers of these components or elements are shown in FIG. 15, any number of these components or elements may be included in the system 1500.

The EDs 1510a-1510c are configured to operate or communicate in the system 1500. For example, the EDs 1510a-1510c are configured to transmit or receive via wireless or wired communication channels. Each ED 1510a-1510c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1520a-1520b here include base stations 1570a-1570b, respectively. Each base station 1570a-1570b is configured to wirelessly interface with one or more of the EDs 1510a-1510c to enable access to the core network 1530, the PSTN 1540, the Internet 1550, or the other networks 1560. For example, the base stations 1570a-1570b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1510a-1510c are configured to interface and communicate with the Internet 1550 and may access the core network 1530, the PSTN 1540, or the other networks 1560.

In the embodiment shown in FIG. 15, the base station 1570a forms part of the RAN 1520a, which may include other base stations, elements, or devices. Also, the base station 1570b forms part of the RAN 1520b, which may include other base stations, elements, or devices. Each base station 1570a-1570b operates to transmit or receive wireless signals within a particular geographic region or area, sometimes referred to as a “cell.” In some embodiments, multiple-input multiple-output (MIMO) technology may be employed having multiple transceivers for each cell.

The base stations 1570a-1570b communicate with one or more of the EDs 1510a-1510c over one or more air interfaces 1590 using wireless communication links. The air interfaces 1590 may utilize any suitable radio access technology.

It is contemplated that the system 1500 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1520a-1520b are in communication with the core network 1530 to provide the EDs 1510a-1510c with voice, data, application, Voice over Internet Protocol (VOIP), or other services. Understandably, the RANs 1520a-1520b or the core network 1530 may be in direct or indirect communication with one or more other RANs (not shown). The core network 1530 may also serve as a gateway access for other networks (such as the PSTN 1540, the Internet 1550, and the other networks 1560). In addition, some or all of the EDs 1510a-1510c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1550.

Although FIG. 15 illustrates one example of a communication system, various changes may be made to FIG. 15. For example, the communication system 1500 could include any number of EDs, base stations, networks, or other components in any suitable configuration.

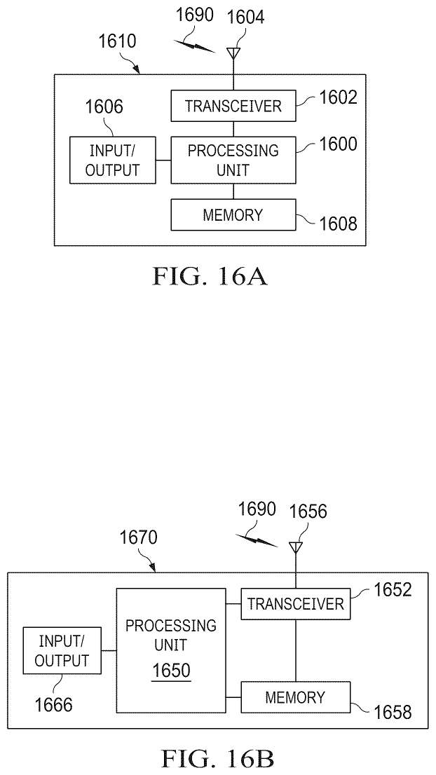

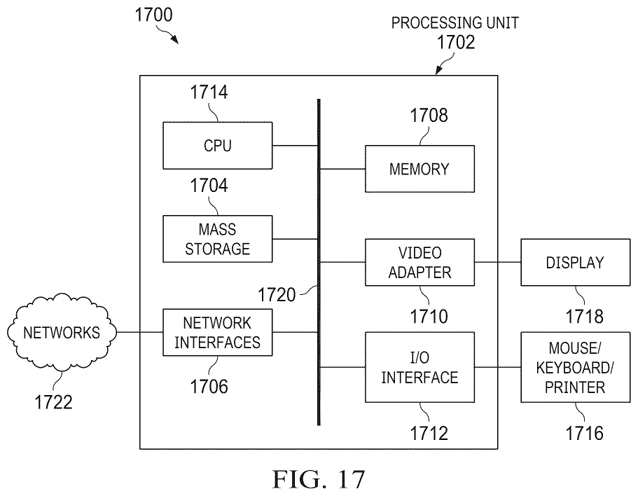

FIGS. 16A and 16B illustrate example devices that may implement the methods and teachings according to this disclosure. In particular, FIG. 16A illustrates an example ED 1610, and FIG. 16B illustrates an example base station 1670. These components could be used in the system 1500 or in any other suitable system.

As shown in FIG. 16A, the ED 1610 includes at least one processing unit 1600. The processing unit 1600 implements various processing operations of the ED 1610. For example, the processing unit 1600 could perform signal coding, data processing, power control, input/output processing, or any other functionality enabling the ED 1610 to operate in the system 1500. The processing unit 1600 also supports the methods and teachings described in more detail above. Each processing unit 1600 includes any suitable processing or computing device configured to perform one or more operations. Each processing unit 1600 could, for example, include a microprocessor, microcontroller, digital signal processor, field programmable gate array, or application specific integrated circuit.

The ED 1610 also includes at least one transceiver 1602. The transceiver 1602 is configured to modulate data or other content for transmission by at least one antenna or NIC (Network Interface Controller) 1604. The transceiver 1602 is also configured to demodulate data or other content received by the at least one antenna 1604. Each transceiver 1602 includes any suitable structure for generating signals for wireless or wired transmission or processing signals received wirelessly or by wire. Each antenna 1604 includes any suitable structure for transmitting or receiving wireless or wired signals. One or multiple transceivers 1602 could be used in the ED 1610, and one or multiple antennas 1604 could be used in the ED 1610. Although shown as a single functional unit, a transceiver 1602 could also be implemented using at least one transmitter and at least one separate receiver.

The ED 1610 further includes one or more input/output devices 1606 or interfaces (such as a wired interface to the Internet 1550). The input/output devices 1606 facilitate interaction with a user or other devices (network communications) in the network. Each input/output device 1606 includes any suitable structure for providing information to or receiving information from a user, such as a speaker, microphone, keypad, keyboard, display, or touch screen, including network interface communications.

In addition, the ED 1610 includes at least one memory 1608. The memory 1608 stores instructions and data used, generated, or collected by the ED 1610. For example, the memory 1608 could store software or firmware instructions executed by the processing unit(s) 1600 and data used to reduce or eliminate interference in incoming signals. Each memory 1608 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 16B, the base station 1670 includes at least one processing unit 1650, at least one transceiver 1652, which includes functionality for a transmitter and a receiver, one or more antennas 1656, at least one memory 1658, and one or more input/output devices or interfaces 1666. A scheduler, which would be understood by one skilled in the art, is coupled to the processing unit 1650. The scheduler could be included within or operated separately from the base station 1670. The processing unit 1650 implements various processing operations of the base station 1670, such as signal coding, data processing, power control, input/output processing, or any other functionality. The processing unit 1650 can also support the methods and teachings described in more detail above. Each processing unit 1650 includes any suitable processing or computing device configured to perform one or more operations. Each processing unit 1650 could, for example, include a microprocessor, microcontroller, digital signal processor, field programmable gate array, or application specific integrated circuit.

Each transceiver 1652 includes any suitable structure for generating signals for wireless or wired transmission to one or more EDs or other devices. Each transceiver 1652 further includes any suitable structure for processing signals received wirelessly or by wire from one or more EDs or other devices. Although shown combined as a transceiver 1652, a transmitter and a receiver could be separate components. Each antenna 1656 includes any suitable structure for transmitting or receiving wireless or wired signals. While a common antenna 1656 is shown here as being coupled to the transceiver 1652, one or more antennas 1656 could be coupled to the transceiver(s) 1652, allowing separate antennas 1656 to be coupled to the transmitter and the receiver if equipped as separate components. Each memory 1658 includes any suitable volatile or non-volatile storage and retrieval device(s). Each input/output device 1666 facilitates interaction with a user or other devices (network communications) in the network. Each input/output device 1666 includes any suitable structure for providing information to or receiving/providing information from a user, including network interface communications.

FIG. 17 is a block diagram of a computing system 1700 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1700 includes a processing unit 1702. The processing unit includes a central processing unit (CPU) 1714, memory 1708, and may further include a mass storage device 1704, a video adapter 1710, and an I/O interface 1712 connected to a bus 1720.

The bus 1720 may be one or more of any type of several bus architectures including a memory bus or memory controller, a peripheral bus, or a video bus. The CPU 1714 may comprise any type of electronic data processor. The memory 1708 may comprise any type of non-transitory system memory such as static random access memory (SRAM), dynamic random access memory (DRAM), synchronous DRAM (SDRAM), read-only memory (ROM), or a combination thereof. In an embodiment, the memory 1708 may include ROM for use at boot-up, and DRAM for program and data storage for use while executing programs.

The mass storage 1704 may comprise any type of non-transitory storage device configured to store data, programs, and other information and to make the data, programs, and other information accessible via the bus 1720. The mass storage 1704 may comprise, for example, one or more of a solid state drive, hard disk drive, a magnetic disk drive, or an optical disk drive.

The video adapter 1710 and the I/O interface 1712 provide interfaces to couple external input and output devices to the processing unit 1702. As illustrated, examples of input and output devices include a display 1718 coupled to the video adapter 1710 and a mouse, keyboard, or printer 1716 coupled to the I/O interface 1712. Other devices may be coupled to the processing unit 1702, and additional or fewer interface cards may be utilized. For example, a serial interface such as Universal Serial Bus (USB) (not shown) may be used to provide an interface for an external device.

The processing unit 1702 also includes one or more network interfaces 1706, which may comprise wired links, such as an Ethernet cable, or wireless links to access nodes or different networks. The network interfaces 1706 allow the processing unit 1702 to communicate with remote units via the networks. For example, the network interfaces 1706 may provide wireless communication via one or more transmitters/transmit antennas and one or more receivers/receive antennas. In an embodiment, the processing unit 1702 is coupled to a local-area network 1722 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method comprising:
receiving, by a federated learning (FL) server network entity from FL client network entities, information about local machine learning (ML) models, each local ML model of the local ML models trained based on respective local training data, the respective local training data being available at a respective FL client network entity of the FL client network entities before the respective FL client network entity receives a corresponding FL training request; and
aggregating, by the FL server network entity, the local ML models to generate an updated global ML model.

2. The method of claim 1, wherein the FL client network entities comprise one or more of at least one core domain network entity, at least one radio access network (RAN) network entity, at least one application function (AF) entity, or at least one user equipment (UE), the at least one RAN network entity including at least one base station, the at least one core domain network entity including an access and mobility management function (AMF) entity, a policy control function (PCF) entity, a session management function (SMF) entity, a user plane function (UPF) entity, a network exposure function (NEF) entity, or a network repository function (NRF) entity.

3. The method of claim 1, further comprising:
determining, by the FL server network entity, based on an analytics identifier (ID) and based on corresponding data collection requirements, whether network function (NF)-based FL is required; and
determining, by the FL server network entity, a mechanism for the NF-based FL.

4. The method of claim 3, further comprising:
performing, by the FL server network entity, based on the mechanism, an NF-based FL registration and discovery procedure.

5. The method of claim 4, the performing the NF-based FL registration and discovery procedure comprising:
sending, by the FL server network entity to a network repository function (NRF) entity, a server registration profile, the server registration profile indicating FL server capability information;
sending, by the FL server network entity to the NRF entity, a discovery request;
receiving, by the FL server network entity from the NRF entity, a discovery response indicating a set of candidate FL client network entities;
sending, by the FL server network entity to the set of candidate FL client network entities, FL learning preparation requests, each of the FL learning preparation requests indicating ML model information, the analytics ID, and the corresponding data collection requirements;
receiving, by the FL server network entity from the set of candidate FL client network entities, FL learning preparation responses; and
selecting, by the FL server network entity, the FL client network entities from the set of candidate FL client network entities based on the FL learning preparation responses.

6. The method of claim 3, further comprising:
performing, by the FL server network entity, based on the mechanism, an NF-based FL training procedure via at least one of enhanced ML model provision or ML model training service operations.

7. The method of claim 6, the performing the NF-based FL training procedure comprising:
receiving, by the FL server network entity from an ML model consumer, a subscription request; and
sending, by the FL server network entity, FL training requests to the FL client network entities,
the receiving the information about the local ML models comprising:
receiving, by the FL server network entity from the FL client network entities, FL training responses including the information about the local ML models.

8. The method of claim 3, the mechanism being a horizontal mechanism, a vertical mechanism, or a horizontal and vertical mechanism.

9. The method of claim 1, wherein the FL client network entities include NF entities of a same NF type.

10. The method of claim 1, wherein the FL client network entities include NF entities of different NF types.

11. The method of claim 1, the FL server network entity being an FL server network data analytics function (NWDAF) entity.

12. The method of claim 1, wherein at least a part of the respective local training data available at the respective FL client network entity is produced by the respective FL client network entity.

13. A method, comprising:
locally generating or collecting, by a federated learning (FL) client network entity, training data;
after the locally generating or collecting, receiving, by the FL client network entity from an FL server network entity, an FL training request;
training, by the FL client network entity, a local machine learning (ML) model based on the FL training request and the training data; and
sending, by the FL client network entity to the FL server network entity, information about the local ML model.

14. The method of claim 13, wherein the FL client network entities comprise one or more of at least one core domain network entity, at least one radio access network (RAN) network entity, at least one application function (AF) entity, or at least one user equipment (UE), the at least one RAN network entity including at least one base station, the at least one core domain network entity including an access and mobility management function (AMF) entity, a policy control function (PCF) entity, a session management function (SMF) entity, a user plane function (UPF) entity, a network exposure function (NEF) entity, or a network repository function (NRF) entity.

15. The method of claim 13, further comprising:
sending, by the FL client network entity to a network repository function (NRF) entity, a network entity registration profile, the network entity registration profile indicating FL client capability information;
receiving, by the FL client network entity from the FL server network entity, an FL learning preparation request, the FL learning preparation request indicating ML model information, an analytics identifier (ID), and corresponding data collection requirements;
determining, by the FL client network entity, to join network function (NF)-based FL corresponding to the local ML model with the FL server network entity based on the FL learning preparation request; and
sending, by the FL client network entity to the FL server network entity, an FL learning preparation response.

16. The method of claim 13, further comprising:
receiving, by the FL client network entity from the FL server network entity, information about an updated global ML model; and
updating, by the FL client network entity, the local ML model based on the updated global ML model.

17. The method of claim 13, wherein at least a part of the training data available at the FL client network entity is produced by the FL client network entity.

18. A federated learning (FL) server network entity comprising:
at least one processor; and
a non-transitory computer readable storage medium storing programming, the programming including instructions that, when executed by the at least one processor, cause the FL server network entity to perform operations including:
receiving, from FL client network entities, information about local machine learning (ML) models, each local ML model of the local ML models trained based on respective local training data, the respective local training data being available at a respective FL client network entity of the FL client network entities before the respective FL client network entity receives a corresponding FL training request; and
aggregating the local ML models to generate an updated global ML model.

19. The FL server network entity of claim 18, the operations further comprising:
determining, based on an analytics identifier (ID) and based on corresponding data collection requirements, whether network function (NF)-based FL is required; and
determining a mechanism for the NF-based FL.
